(19) United States
(12) Patent Application Publication
(10) Pub. No.: US 2009/0238524 A1
(43) Pub. Date: Sep. 24, 2009

(54) Apparatus for Thermal Connection of Optical Fibers, and Method for Thermal Connection of Optical Fibers

(76) Inventors: Rainer Matthias Kossat, Aschau (DE); Christian Heidler, Munchen (DE)

Correspondence Address: CORNING INCORPORATED, INTELLECTUAL PROPERTY DEPARTMENT, SP-TI-3-1, CORNING, NY, 14831, US

(21) Appl. No.: 12/473,612

(22) Filed: May 28, 2009

Related U.S. Application Data
(63) Continuation of application No. PCT/EP2007/062347, filed on Nov. 14, 2007.

(30) Foreign Application Priority Data
Nov. 29, 2006 (DE) 102006056398.0

(51) Int. Cl. G02B 6/255

(52) U.S. Cl. 385/96

(57) ABSTRACT

Disclosed is an apparatus for thermal connection of at least two optical fibers having a first positioning unit associated with the first optical fibers and a second positioning unit associated with the second optical fibers. The positioning units move ends of the first and of the second optical fibers relative to one another to a position which allows thermal connection. The apparatus also has a heat source with a first component and a second component which are arranged along an axis. An observation device is used to determine the distance of the end of at least one of the at least two optical fibers from the axis. The observation device is coupled to a control apparatus that adjusts at least one control parameter for the heat source as a function of the determined distance.

### CROSS-REFERENCE TO RELATED APPLICATIONS

This application is a continuation of International Application No. PCT/EP2007/062347, filed Nov. 14, 2007, which claims priority to German Application No. 102006056398.0, filed Nov. 29, 2006, both applications being incorporated herein by reference.

### FIELD

The disclosure relates to an apparatus for thermal connection of at least two optical fibers. The disclosure also relates to a method for thermal connection of respective ends of at least two optical fibers.

### TECHNICAL BACKGROUND

Apparatuses for connection of optical fibers by means of heat influence are referred to as splicers. In splicers, the fiber ends of the optical fibers to be connected are heated, as a result of which they are fused to one another. The fusion process is also referred to as splicing. Different attenuations can occur within the connection, depending on the position of the two optical fibers with respect to one another and further parameters such as the splicing temperature or splicing time that is used. It is, of course, desirable for the resultant attenuation after a splicing process to be as low as possible, in order to avoid unnecessarily reducing the signal quality.

In order to improve the quality of a spliced connection such as this, it is known for the ends of the optical fibers to be spliced to be aligned accurately with respect to one another. By way of example, an arc, a corona discharge, a laser beam or some other form of a heat source is then used to melt the fiber ends before joining them together.

Electromechanical motors or piezoelectric elements, inter alia, can be used for the alignment or positioning of the two fiber ends with respect to one another. Each of the respectively used positioning types has its own positioning accuracy. For example, stepping motors and the associated step-down conversion are available at low cost, but the positioning accuracy of this mechanism is less than that of piezoelectric elements.

Splicers have recently been required which can be produced at low cost and are intended to be as reliable as possible during use, simple to operate, and to require little maintenance. The splicers are generally designed to be portable and are frequently used for installation of optical fibers in buildings. Portable splicers frequently have no complex and accurate positioning mechanism, for cost reasons. Other splicers, for example as known from U.S. Pat. No. 6,230,522, use a complex recording and alignment electronics in order to ensure that the optical fibers are aligned as accurately and reproducibly as possible with respect to one another at the start of a splicing process. To this end, the actual splicing process is then carried out using a fixed splicing current, and for a fixed splicing time.

Irrespective of the splicer that is used, the increasingly stringent requirements for signal quality make it necessary to further reduce the attenuation caused by the splicing process between different optical fibers. It is therefore desirable to provide an apparatus of the type mentioned initially, by means of which the quality of a thermal connection of two optical fibers can be improved further. At the same time, it should still be possible to operate the apparatus easily. A further aim is provide a method which offers a better splice quality.

### SUMMARY

One embodiment of the present application provides for two positioning units to be provided in an apparatus for thermal connection of at least two optical fibers, with one optical fiber being associated with each of these positioning units. The positioning units are designed such that the ends of the two optical fibers can be moved relative to one another to a position which allows thermal connection. A device having a first component and a second component is provided for the heating which is required for the thermal connection of the ends of the first and second optical fibers. The two components are arranged along one axis.

In order to improve the quality of a thermal connection of the two optical fibers, an observation device is provided, by means of which the distance of the end of at least one of the at least two optical fibers from at least one of the components of the device for heating can be determined. Alternatively, it is possible to determine the distance from the axis along which the components of the device are arranged. The observation device is coupled to a control apparatus, which is designed for adjustment of at least one control parameter for the device for thermal connection, as a function of the distance.

The position of the ends of the two fibers relative to a heat source is recorded for the process of thermal connection. This allows the distance of the two ends of the optical fibers from the heating source to be determined accurately. The distance is taken into account in the adjustment of control parameters which are important for the splicing process. Furthermore, it is possible to use the existing positioning units together with the observation device to additionally determine the two ends of the optical fibers relative to one another. This further improves the quality of the spliced connection.

In one embodiment, a memory is provided in the control device, in which memory values are stored which represent a predetermined relationship between a possible distance and the at least one control parameter. Alternatively, the control apparatus or the memory may have an appropriate calculation rule which provides a relationship between values of possible distances and the at least one control parameter. This makes it possible to select from a multiplicity of possible settings of a control parameter those parameters which are optimum for the respective distance. Further control parameters may now be selected, by means of which the heat source is then operated for the actual process of connecting the two optical fibers. Alternatively, when an already known calculation rule is used, it is possible to determine the optimum value of one or more control parameters directly from the determined distance.

In one embodiment, the at least one control parameter is linked, for example, to a supply current of the heat source or to an amount of heat produced by the heat source. It is likewise possible to adjust the time duration during which the fiber ends are heated, as a function of the determined distance. In addition, different temperature ranges can be selected as a function of the determined distance for the process of connecting the fiber ends. Further options are to adjust a pre-splicing current for the heating of the fiber ends, and/or the time duration for heating of the fiber ends, before the actual connection process, with the aid of the at least one control parameter.

In one embodiment, the positioning units can be fixed in position with respect to one another by evaluation of the distance of the two optical fibers from the heat source or from an axis along which the heat source or components of the heat source is or are arranged. The proposed apparatus can therefore also be used in simple appliances without complicated positioning elements.

In another embodiment, the heat source comprises a pair of electrodes which are arranged along the axis. In another embodiment, again, the heat source contains a laser device which produces a laser light beam along the axis. It is likewise possible for a resistance wire or heating wire to be provided as the heat source. This is arranged along the axis.

In another embodiment, a heat source is provided which has two components arranged along one axis. The two optical fibers to be connected are positioned relative to one another such that they can be connected by heat influence with the aid of the heat source. An image of the ends of the at least two optical fibers with respect to the axis is then recorded. This image is used to determine the distance of at least one end of the two optical fibers from the axis. A value is produced from this, which indicates a dependency between a possible distance and a control parameter which influences the heat produced by the heat source. The heat source is then operated as a function of the control parameter, in order to connect the ends of the at least two optical fibers to one another. The splicing process is controlled individually for each connection by operating the heat source with the aid of the control parameter from the determined distance. By way of example, this makes it possible to correct the different positions of the optical fibers with respect to the axis, thus producing a splice result which is independent of the distance.

The concepts will be explained in more detail in the following text with reference to a plurality of exemplary embodiments which are illustrated in the drawings. Components which have the same effect or the same function are provided with the same reference symbols in the various figures.

### BRIEF DESCRIPTION OF THE DRAWINGS

FIG. 1 shows an outline circuit diagram with essential elements of a splicer according to a first embodiment;

FIG. 2 shows an outline circuit diagram of a splicer according to a second embodiment;

FIG. 3 shows a view of a detail of the area of the splicer, in which the process of splicing the ends of the optical fibers is taking place;

FIG. 4 shows a view of a detail of a splicer according to a further embodiment;

FIG. 5 shows a view of a detail of a further embodiment;

FIG. 6 shows one exemplary embodiment for the procedure for one embodiment of a method for thermal connection.

### DETAILED DESCRIPTION

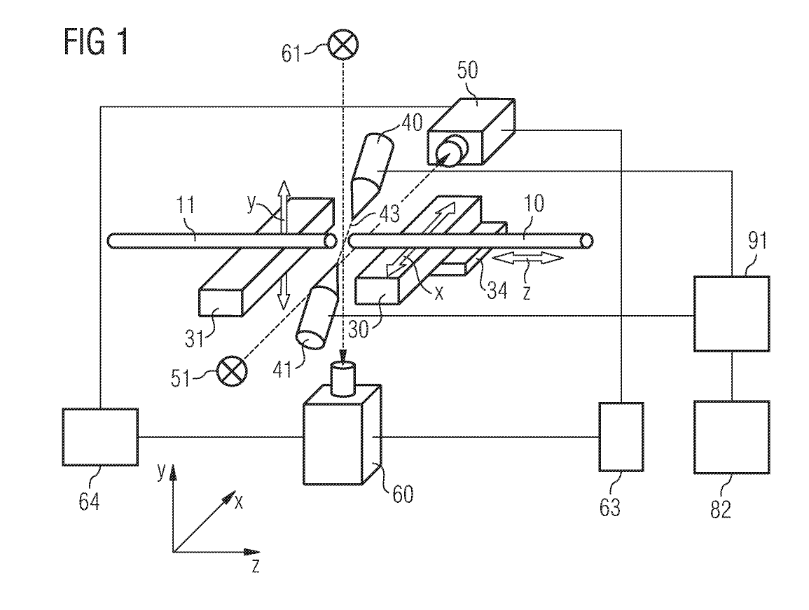

FIG. 1 shows a splicer for thermal connection of ends of two optical fibers 10, 11. The two optical fibers 10, 11 are arranged opposite one another and fixed on positioning tables 30, 31. The positioning table 31 can be moved along the y direction, for example with the aid of piezoelectric elements or electrical stepping motors, which are not illustrated here. Movement with the aid of an electrically operated stepping motor and a spindle, or some other step-up transmission, currently provides relatively high positioning accuracy. However, this is less than the positioning accuracy which can be achieved by piezo-ceramics, which is in the order of magnitude of about 0.06 μm to 0.01 μm. The stepping motor mechanism provides a positioning accuracy in the lowest case of 1 μm, and typically from 5 μm to 6 μm. The positioning table 30 can be moved in a corresponding manner along the x-direction. Furthermore, a plate 34 is provided for the positioning table 30, with the aid of which the positioning table 30 and the optical fiber 10 fixed on it can be moved along the z-direction.

A heat source having the two components 40 and 41 is provided in order to produce the heat required for thermal connection of the two ends of the optical fibers 10 and 11. The two components 40, 41 represent electrodes whose electrode tips are arranged specifically with respect to one another along an axis 43. The two optical fibers 10, 11 are positioned between them and essentially at right angles to the axis. The electrodes are connected to an electrical power source 91 in order to operate the two electrodes 40, 41 and to supply them with the supply current which is required for production of an arc.

According to the embodiment shown in FIG. 1, the splicer has two cameras 50, 60 in order to accurately determine the distance of the optical fibers 11, 10, from the axis 43 and to determine a relative position with respect to one another. In this case, the camera 50 is arranged along the x-direction and the camera 60 is arranged along the y-direction, such that they can record images from the area of the axis 43 of the heat source as well as the ends of the two optical fibers 10, 11 within the splicing area. To this end, light sources 51 and 61 are additionally provided opposite the cameras, for better illumination and in order to improve the contrast. The imaging cameras 50 and 60 are, for example, in the form of charge coupled devices (CCD). These cameras provide an image, resolved into pixels, in digital form for the evaluation control unit 63. The control apparatus 64 is provided in order to operate the two imaging cameras 50 and 60 and the light sources 51 and 61.

The images produced by the cameras 50 and 60 are passed on to the microprocessor 63, where they are evaluated. The microprocessor sets the position of the optical fibers 10, 11 in conjunction with the position of the fixed-mounted cameras. The position of the fibers 10, 11 relative to one another and the distance of the two fibers from the axis 43 of the heat source can be determined accurately, taking account of the recording parameters of the position image.

During operation of the splicer, the positioning of the fibers 11, 10 with respect to one another, for example, is recorded for the splicing process such that the relative offset is reduced as much as possible. The fiber 10 is then moved along the z-direction, such that both fiber ends are now arranged symmetrically about the axis 43 of the heat source.

The distance of the fiber ends from the axis 43 is determined in order to improve the actual splicing process and therefore to reduce the attenuation losses after the two fiber ends have been connected. The microprocessor 63 passes this distance to a control apparatus 82 in which, in the present embodiment, a calculation rule is stored. The control apparatus 82 uses the calculation rule to produce a plurality of control parameters, in order to control the splicing process as a function of the determined distance of the two fiber ends from the axis 43. By way of example, these control parameters include the time duration for a pre-splicing current in the two electrodes 40 and 41 for heating of the two optical fiber ends. Before being melted, the ends are heated for a certain time with the aid of the pre-splicing current, and are therefore prepared for the splicing process.

This makes it possible to take account of greater or lesser distances of the two fiber ends from the axis 43 during the heating of the two fiber ends which precedes the actual splicing process. Furthermore, the amount of heat and the splicing time for the splicing process that is then carried out are controlled as a function of the distance of the two fiber ends from the axis 43. In addition, the offset of the two fiber ends, which is recorded by the cameras and is evaluated in the microprocessor 63, with respect to one another is taken into account for the splicing process.

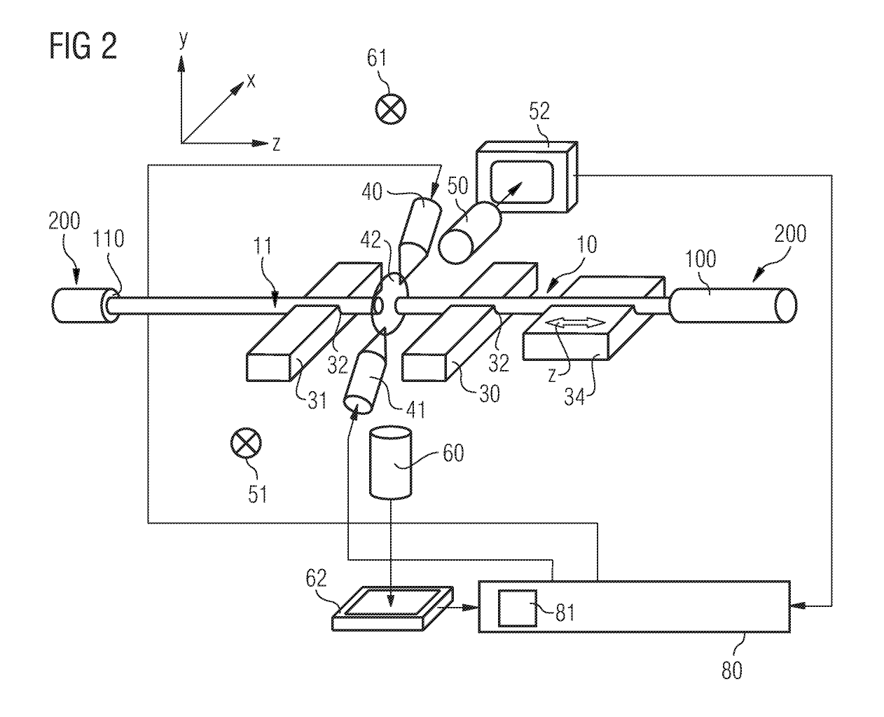

FIG. 2 shows an outline circuit diagram of a further embodiment of a splicer. In this splicer, the two positioning units 30 and 31 are fixed firmly in their position with respect to one another. Furthermore, they have two grooves 32 whose circumferences correspond to the external circumference of the two optical fibers 10 and 11. The fibers are placed in the respective grooves 32 in the positioning units, and are fixed there. By way of example, the grooves 32 can be ground in ceramic or else can be etched in silicon, and are therefore accurate to small fractions of a micrometer, by virtue of the production technique.

In the present embodiment, the positioning units 30 and 31, and therefore the grooves 32, are arranged in exact positions with respect to one another. The positioning accuracy of the optical fibers 11, 10 which have been placed in the grooves is governed directly by the position of the fibers 10, 11 in the grooves 32. The position of the optical fibers 10 and 11 can be changed manually.

In this case, the optical fibers are in the form of glass fibers with one or more light-carrying cores. Those ends of the optical fibers which are arranged in the splicing area originate from an optical waveguide 200. The latter in each case comprises its jacket 100 or 110, which is at a distance from the optical fibers 10 or 11, outside the splicing area. The actual glass fiber is therefore exposed in the splicing area. All known types of optical waveguides are suitable as optical fibers, but in particular single-mode fibers or NZD fibers (non-zero-dispersion-shifted fibers).

The optical fiber 10 can be moved along its z-direction with the aid of a sliding table 34, which likewise has a V-shaped groove. In addition, cameras 50 and 60 are arranged in the x-direction and z-direction, respectively. Lighting elements 51 and 61 are used for illumination, are associated with the imaging cameras 50 and 60 and illuminate the splicing zone 42.

During operation, once the two optical fibers 10 and 11 have been fixed and positioned in the grooves 32 in the positioning units, the two cameras 50 and 62 produce a respective position image 52 and 62. The two position images, which are supplied to a microprocessor 80 for further evaluation, can be used to determine the distance of the end of the optical fiber 11 from the two tips of the electrodes 40 and 41. For a uniform splicing process of both ends, the position of the optical fibers 10 is now changed in the z-direction with the aid of the positioning unit 34. The ends of the two optical fibers are arranged as far as possible at the same distance around the tips of the two electrodes 40 and 41 and at the same distance from the electrode tips. This results in the two fiber ends being heated uniformly.

Control parameters are selected from the memory 81 in the microprocessor 80, as a function of the determined distance of the two fiber ends from the axis of the electrode tips. The pre-splicing current, the pre-splicing time duration, the splicing current or the time duration for the splicing process are now set for the subsequent splicing process with the aid of the control parameters. The splicing parameters are therefore controlled as a function of the distance of the fiber ends from the tips of the splicing electrodes, thus resulting in a splicing result which is independent of this distance.

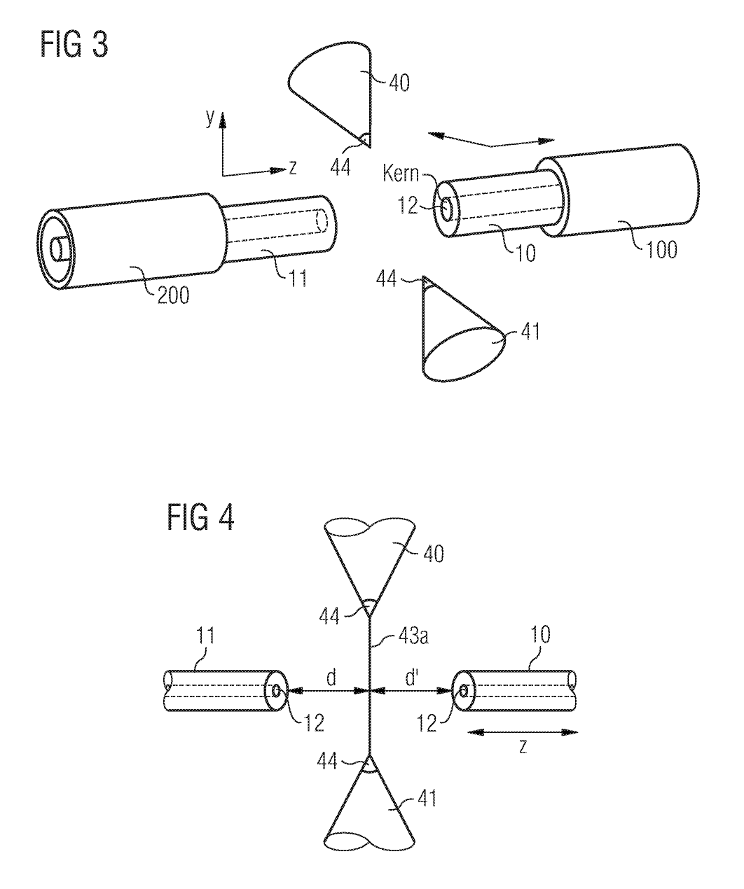

There are several possible ways to determine the distance of the respective glass fibers or optical fibers from the heat source. FIG. 3 shows one example, in which the arc which exists between two electrodes is used as a reference for determining the distance. The optical fibers 10 and 11 illustrated here are coated with a coating 100 and 200, respectively. Furthermore, they each have a core 12, whose refractive index is different from that of the glass jacket that surrounds them. The cores of the two optical fibers 10 and 11 are now aligned as exactly as possible with respect to one another. An arc is then briefly produced with the aid of the two electrodes 40 and 41. This arc has a light intensity whose maximum should be located on a connecting axis between the tips 44 of the two electrodes 40, 41. While the arc is being produced, an image is recorded with the aid of the two cameras. The distance of the ends of the optical fibers from the connecting axis between the tips of the two electrodes 40 and 41 can be determined from the intensity distribution and from the information about the ends of the two optical fibers 10 and 11.

FIG. 4 shows a perspective view in the splicing area of a further exemplary embodiment. A heating wire 43a runs on the connecting axis between the tips 44 of the two elements 40 and 41. This heating wire 43a is heated by current flowing through it, and thus forms the heat source. The heating current is supplied via the tips 44.

The optical fiber 11, with its core 12, is arranged in a groove, which is not illustrated, in a positioning element, at a fixed distance d from the heating wire 43a. The cameras record an image of the position of the end of the optical fiber 11 from the tips 44 of the two electrodes and from the heating wire 43a. The distance d can be deduced from the recorded images. The optical fiber 10 is then moved along its z-direction until its distance d′ from the heating wire 43a corresponds to the distance d. The two ends of the optical fibers 10 and 11 are arranged at the end of the positioning process at the same distance around the wire 43a. The appropriate control parameters for the subsequent splicing process are calculated as a function of the distance d, and the thermal connection is thus produced.

By way of example, it may be expedient to provide a greater splicing current or longer splicing times if the distances are relatively great. Pre-splicing currents and/or pre-splicing times may also possibly be changed. In one alternative embodiment, for example, a pre-splicing time can also be used to determine the distance d and d′ of the optical fibers from the wire 43a. It is therefore possible to determine control parameters, by means of which the subsequent splicing process will be controlled, during the time period in which the two optical fibers are heated.

FIG. 5 shows a further perspective view of the splicing area in another embodiment of an apparatus. In this refinement, an auxiliary void 430 is additionally provided. This is arranged on the same plane as the connecting axes between the tips 44 of the two electrodes 40 and 41 and is essentially at right angles to the longitudinal direction of the optical fibers 10 and 11. As illustrated here, the two optical fibers 10 and 11 are physically offset with respect to one another. This offset can be determined and reduced as much as possible during a positioning phase prior to the splicing process. Furthermore, the self-centering effect which occurs during the splicing process corrects any minor offset between the two ends of the optical fibers, thus resulting in a desired resultant attenuation of the light propagation.

In another embodiment, a laser beam is provided as the heat source. In this embodiment, the laser beam can be activated with as low an intensity as possible prior to the splicing process, for positioning and determining the distance of the two fiber ends from the laser beam. The image of the laser beam and the ends of the two optical waveguides with respect to one another can be recorded with the aid of a camera with accurate positioning thus being carried out.

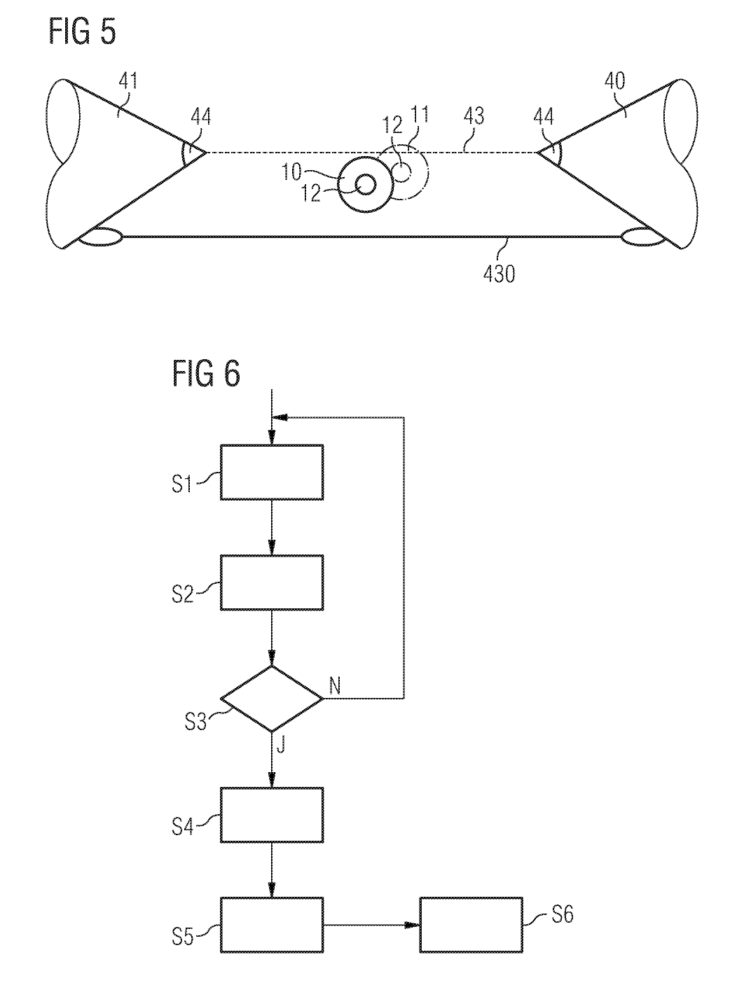

Finally, FIG. 6 shows a flowchart for one embodiment of a method for thermal connection of optical fibers. Once the optical fibers have been positioned and fixed in the positioning units, they are moved with respect to one another in step S1, and the ends of the two optical fibers are arranged roughly with respect to one another. In step S2, the imaging cameras record an image of the two ends of the fibers with respect to one another, and the position with respect to a heat source for the subsequent connection process. The recorded image is evaluated, in order to determine the position of the fiber elements in three-dimensional space.

A decision is then made in step S3 as to whether the position of the fiber ends with respect to one another is below a predetermined threshold value. If this is not the case, a readjustment process must therefore be carried out, and the method is continued with a further iteration in step S1. If, in contrast, the predetermined limit value is undershot in step S3, the positioning of the fiber ends with respect to one another has been completed. The rest of the splicing process can then be continued in step S4.

There, another image of the fiber ends is now recorded with respect to an axis associated with the heat source. The distance of the two fiber ends from the heat source is determined with the aid of these records.

The determined distance is made to coincide in step S5 with control parameters which are used for the subsequent splicing process. The splicing time or else the heat developed by the heat source is controlled with the aid of the control parameters. The process is then carried out in step S6, as a function of the distance and the positioning of the fibers with respect to one another.

The recording of another image in step S4 after positioning of the fiber ends with respect to one another may also be omitted if the recording of an image of the fiber ends in step S2 likewise includes the recording of the image of the fiber ends with respect to an axis which is associated with the heat source. The most recently recorded image of the splicing area before completion of the positioning steps is then used to determine the distance. In step S5, the control parameters are determined from the distance that has been determined in this way.

It is likewise possible, at least in some cases, to carry out the individual method steps during a pre-splicing process. In particular, it is possible to record an image of the fiber ends during a pre-splicing process in step S4. When an arc is produced or a laser beam is used during the pre-splicing process, the distance between the axis associated with the heat source and the fiber ends can thus be determined from the light intensity distribution and the fiber ends. An image can also be recorded particularly easily when using a heating wire as the heat source.

The arrangement and the corresponding method allow uniform heating of the two fiber ends in the heating source. This is achieved by using a camera system in a splicing system, by means of which camera system the position of the fiber ends of the optical fibers relative to the heating source can be recorded. The image recorded by the observation device is then evaluated. Splicing parameters such as the splicing current, the time during which the fibers are heated or else different temperature levels which are passed through during the splicing process can then be set as a function of the actual position of the fiber ends with respect to the heating source. These splicing parameters can be stored as a parameter matrix in a memory. It is likewise possible to determine these splicing parameters from a known relationship rule, taking account of the determined distance. The splicing procedure is therefore not carried out with constant splicing parameters, but with the splicing parameters being adapted as a function of the actually determined position of the fibers with respect to the heating source. The position of the fiber ends with respect to the heating source can advantageously be measured by means of electrodes within the recorded image, an auxiliary void, an averaged intensity distribution of an arc, or of a laser beam, by means of the camera image.

Many modifications and other embodiments of the present invention, within the scope of the appended claims, will become apparent to the skilled artisan. Therefore, it is to be understood that the invention is not limited to the specific embodiments disclosed herein and that modifications and other embodiments may be made within the scope of the appended claims. Although specific terms are employed herein, they are used in a generic and descriptive sense only and not for purposes of limitation.

We claim:

1. An apparatus for thermal connection of at least two optical fibers, comprising:
a first positioning unit, which is associated with a first of the optical fibers, and a second positioning unit, which is associated with a second of the optical fibers, which positioning units are designed to move ends of the first and of the second optical fibers relative to one another to a position which allows thermal connection;
a device having a first component and a second component, which are arranged along an axis, wherein the device is designed to heat the ends of the first and second optical fibers in order to allow thermal connection;
an observation device, by means of which the distance of the end of at least one of the at least two optical fibers from one of the components or from the axis can be determined;
a control apparatus which is coupled to the observation device and is designed for adjustment of at least one control parameter for the device for thermal connection, as a function of the distance.

2. The apparatus of claim 1, wherein the control apparatus includes a memory in which values are stored which represent a predetermined relationship between a possible distance and the at least one control parameter.

3. The apparatus of claim 1, wherein the control apparatus or the memory has a calculation rule, which provides a relationship between values of possible distances and the at least one control parameter.

4. The apparatus of claim 1, wherein the at least one control parameter represents a supply current for the device or an amount of heat produced by the thermal device or an operating time duration of the device, during which the heat influence is produced in order to melt the ends of the optical fibers, or a combination of at least two of the said parameters supply current, amount of heat and operating time duration.

5. The apparatus of claim 1, wherein the positioning units which are associated with the optical fibers each have a groove for holding a section of the optical fibers to be connected.

6. The apparatus of claim 1, wherein the positioning units are fixed in position with respect to one another.

7. The apparatus of claim 1, wherein the first positioning unit can be moved at least along the longitudinal direction of the first optical fiber, and the second positioning unit can be moved at right angles to the optical fiber.

8. The apparatus of claim 1, wherein the first and the second component of the device each have an electrode, by means of which an electrical discharge can be produced for melting and thermal connection of the ends of the first and second optical fibers.

9. The apparatus of claim 8, wherein the electrical discharge is an arc or a corona discharge.

10. The apparatus of claim 8, wherein the control apparatus controls the current supplied to the electrodes and/or the time duration of the supplied current.

11. The apparatus of claim 1, wherein at least one component of the device is a laser device that produces a laser light beam to melt and to connect the ends of the optical fibers, with the control apparatus controlling a current supplied to the laser device and/or the time duration during which the laser device is supplied with a current in order to form the laser light beam.

12. The apparatus of claim 1, wherein at least one of the components of the device comprises a heating wire which is arranged along the axis, in order to connect the ends of the optical fibers by heat influence, with the control apparatus controlling a current supplied to the heating wire and/or the time duration for which a current is supplied to the heating wire.

13. The apparatus of claim 1, wherein the observation device comprises at least one camera in order to record an image of the ends of the at least two optical fibers transversely with respect to a longitudinal axis of the optical fibers, with respect to the axis.

14. The apparatus of claim 13, wherein at least two cameras are provided, in order to record at least two images of the ends of the at least two optical fibers from at least two different directions transversely with respect to the longitudinal axis of the optical fibers, with respect to the axis.

15. A method for thermal connection of respective ends of at least two optical fibers, comprising:
providing a heat source having two components which are arranged along an axis;
positioning of the ends of the at least two optical fibers relative to one another, so as to allow a connection by heat influence;
recording of an image of the ends of the at least two optical fibers with respect to the axis;
determining a distance of at least one end of the at least two optical fibers from the axis;
providing a value which provides a relationship between a possible distance and a control parameter which influences the heat produced by the heat source;
operation of a heat source as a function of the control parameter, in order to connect the ends of the at least two optical fibers.

16. The method of claim 15, wherein the control parameter contains at least one of following parameters:
a time duration for the production of heat by the heat source for connection of the ends of the at least two optical fibers;
a time duration for the production of heat by the heat source for heating of the ends of the at least two optical fibers before the step of connection of the ends;
a supply current or a supply voltage for the heat source in order to adjust the magnitude of the heat influence;
a variable which controls the heat produced by the heat source, with the heat that is produced acting during the connection of the ends;
a variable which controls the heat produced by the heat source, with the heat that is produced acting on the ends of the at least two optical fibers before the step of connection of the ends.

17. The method of claim 16, wherein during the time duration for which heat is produced, a pair of electrodes are supplied with current in order to produce an arc or a corona discharge, or a laser beam is produced.

18. The method of claim 15, further comprising:
providing a memory in which a table is stored with values which indicate a relationship between a possible distance and the control parameter which influences the production of heat.

19. The method of claim 15, further comprising:
providing a memory which contains a calculation rule from which a time duration for the operation of the heat source or an amount of heat to be produced by the heat source is calculated as a consequence of an input of the determined distance.

20. The method of claim 15, wherein the step of positioning comprises:
(a) recording of an image of the ends of the at least two optical fibers;
(b) determining an offset between the ends of the at least two optical fibers with respect to one another;
(c) movement of at least one of the optical fibers in order to reduce the offset; and
(d) repetition of steps (a)-(c) until a predetermined limit offset is reached or undershot.

21. The method of claim 20, wherein the image of the ends of the at least two optical fibers is recorded with respect to the axis.

22. The method of claim 20, wherein the distance between external contours of the ends of the at least two optical fibers is found in order to determine the offset.

23. The method of claim 15, wherein the ends of the at least two optical fibers are moved towards one another along a longitudinal direction (z) of the optical fibers while the heat source is being operated in order to connect the ends of the at least two optical fibers.

24. The method of claim 15, wherein images of the ends of the at least two optical fibers are determined from directions which differ from one another by 90 degrees.

25. The method of claim 15, wherein the at least two optical fibers are fibers of the non-zero-dispersion-shifted fiber type.

26. A method for thermal connection of respective ends of a multiplicity of optical fibers, in which respective ends of at least two optical fibers are selected, and the ends of these at least two optical fibers are then connected using the method according to claim 15, at least two further optical fibers are then selected and the ends of these at least two further optical fibers are connected using the method according to claim 15.
